(19) United States
(12) Patent Application Publication
(10) Pub. No.: US 2016/0081301 A1
(43) Pub. Date: Mar. 24, 2016

(54) EQUINE EAR WARMERS

(71) Applicant: Patricia Helen Thomson, Lake Cowichan (CA)

(72) Inventor: Patricia Helen Thomson, Lake Cowichan (CA)

(21) Appl. No.: 14/495,328

(22) Filed: Sep. 24, 2014

(51) Int. Cl. A01K 13/00

(52) U.S. Cl. CPC A01K 13/006

(57) ABSTRACT

An equine ear warmer garment including a strap for placement around a head of a horse. The garment also includes a pair of substantially conical-shaped protrusions located on a top of said strap and composed of a first material exhibiting heat insulative and water resistant capabilities. Each conical-shaped protrusion designed for accepting an ear of a horse. A portion of each conical-shaped protrusion includes a material that allows substantially full transmission of sound from an exterior source into an interior of each conical-shaped protrusion. The garment also includes a hook and loop fastener located on the ends of the strap such that the ends of the strap may be coupled under the horse's head when the ear warmer garment is worn.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The disclosed embodiments relate to the field of horses and equestrian accoutrements. And more specifically to the field of equestrian health-care in cold weather.

### BACKGROUND

Horses have been a part of people's lives for centuries. Many individuals keep horses as pets, companions, and in some cases, animals used for work. In cold weather, low temperatures can cause horses to grow long coats to protect their body. However, sometimes such coats are not enough to protect a horse's ears. In extremely cold weather, especially below 0° C. and in wet weather, horses can occasionally develop disease or frostbite on the ears due to the low temperature. This can cause discomfort for the horse, and, if left untreated, can cause equine infection and sickness. The prior art does not adequately provide a device that protects the ears of horses in extremely cold weather. Therefore, there is a need to overcome the problems with the prior art, and more specifically, a need for a device that protects the ears of a horse in extremely cold and wet weather.

### SUMMARY

In one embodiment, the invention discloses an equine ear warmer garment comprising a strap for placement around a head of a horse. The strap is composed of a first material exhibiting heat insulative and water resistant capabilities. A pair of substantially conical-shaped protrusions are located on a top of said strap and composed of said first material. Each conical-shaped protrusion is designed for accepting an ear of a horse. A mesh material comprises a portion of each conical-shaped protrusion such that said mesh material interrupts said first material. The mesh material allows substantially full transmission of sound from an exterior source into an interior of each conical-shaped protrusion. A hook portion of a hook and loop fabric is located on a first end of the strap, such that said hook portion is located on a segment of the strap located under the horse's head when the ear warmer garment is worn. A loop portion of hook and loop fabric is located on a second end of the strap, such that said loop portion of the first end of the strap is coupled with the hook portion of the second end of the strap when the ear warmer garment is worn.

The foregoing and other features and advantages of the disclosed embodiments will be apparent from the following more particular description of the preferred embodiments, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the disclosed embodiments will be apparent from the following detailed description taken in conjunction with the accompanying drawings. Additionally, the left-most digit of a reference number identifies the drawing in which the reference number first appears:

FIG. 1 is a front view of an equine ear warmer, in accordance with one embodiment.

FIG. 2 is a perspective view of an equine ear warmer, in accordance with one embodiment.

### DETAILED DESCRIPTION

The following detailed description refers to the accompanying drawings. Wherever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosed embodiments. Instead, the proper scope of the disclosed embodiments is defined by the appended claims.

The disclosed embodiments improve upon the problems with the prior art by providing a device that protects a horse's ears from the cold. The disclosed embodiments further provides a mechanism for preventing injury to a horse while wearing the device by allowing the device to be removed if sufficient forces act upon it. The device also includes a mechanism that allows only a minimal amount of a horse's hearing to be affected while wearing the invention. Lastly, the disclosed embodiments protect a horse's ears from becoming wet, due to its water proof capabilities.

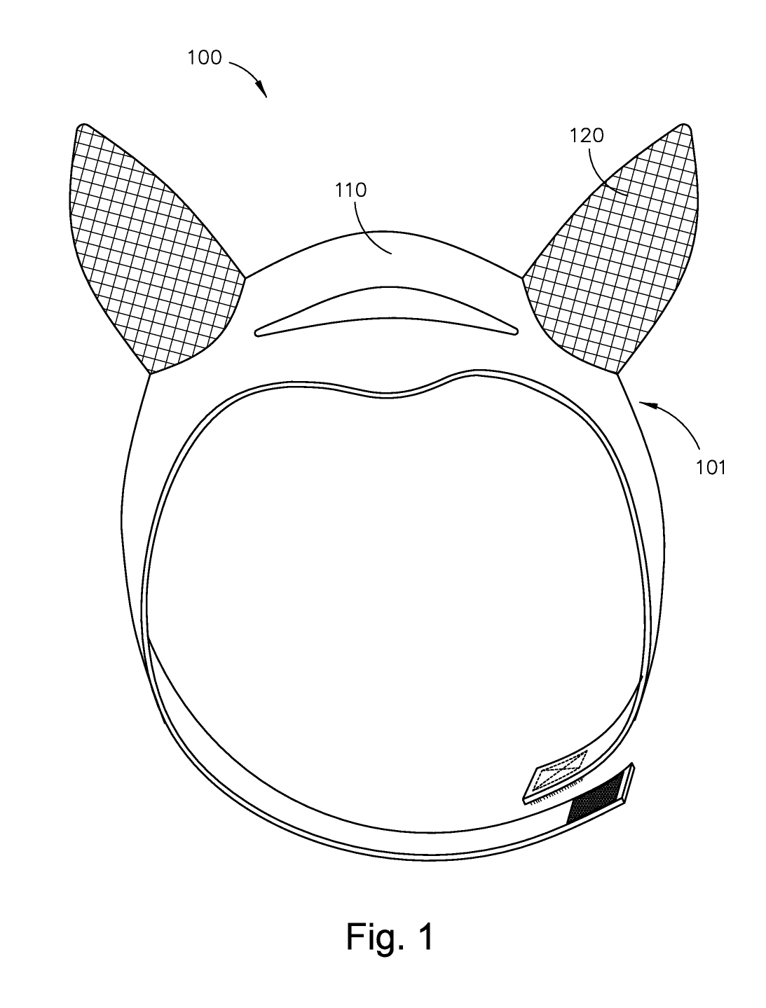

Referring now to the Figures, FIG. 1 is a front view of an equine ear warmer 100, in accordance with one embodiment. The ear warmer includes a strap 101 for placement around the head of a horse. The strap can be an elongated rectangular shape, such as strip of fabric. The strap is composed of a first material, exhibiting heat insulative and water resistant capabilities, such as a waterproof breathable fabric or membrane composed of PTFE. The heat insulative and water resistant capabilities allow the disclosed embodiments to facilitate preventing frostbite to portions of a horse's ears, such as the tips of the ears. Further examples of heat insulative and water resistant materials include fleece, goose down surrounded by waterproof material or any other material known to those skilled in the art. In another embodiment, the heat insulative and water resistant material may be a natural or synthetic fabric that is laminated to or coated with a waterproofing material such as rubber, polyvinyl chloride (PVC), polyurethane (PU), silicone elastomer, fluoropolymers, and wax.

A pair of substantially conical-shaped protrusions 120 are located on a top 110 of the strap. The top of the strap is sized such that it sits between a horse's left ear and right ear. Each substantially conical-shaped protrusion is designed for accepting an ear of a horse. These substantially conical-shaped protrusions can also be known as ear cups. The size and shape of each ear cup or protrusion and the strap can be adapted to fit the size and shape of the animal. Each of these substantially conical-shaped protrusions are composed of the first material exhibiting heat insulative and water resistant capabilities. The first material keeps the ears of the horse warm, and dry and also prevents injury such as frostbite to a horse's ears. In another embodiment, the ear cup may have other shapes such as a cubical shape, triangular pyramid, square pyramid, triangular prism, a wedge, a tetrahedron, an octahedron, or the like.

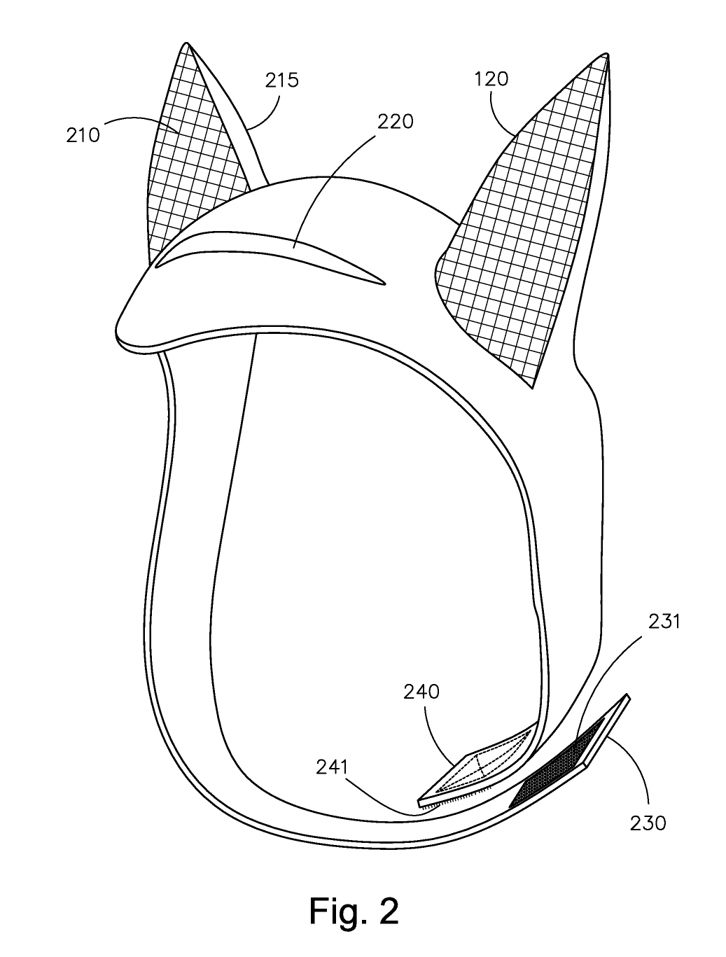

FIG. 2 is a perspective view of the equine ear warmer garment, in accordance with one embodiment. FIG. 2 illustrates that a portion 210 of each ear cup includes a mesh material. The mesh material interrupts the first material and allows substantially full transmission of sound waves or sound from an exterior source into an interior of each ear cup. A portion of each ear cup comprising the first material can be seen in FIG. 2 as 215. The mesh material portion of the ear cup is adapted such that when the ear cups receive each of the horse's ears, the opening of each ear is proximate to the mesh material. The mesh material may be comprised of natural material such as cotton, or can be made from synthetic materials such as plastic, polyester, vinyl, etc. The mesh material can be sown or stitched together to the remainder of each ear cup or for some other means. The mesh material may be any loosely woven or knitted fabric that has a large number of closely spaced holes.

The strap 101 has a first end 230 opposing a second end 240. A hook portion 231 of a hook and loop fabric is located on the first end of the strap, such that the hook portion is located on a segment of the strap located under the horse's head when the ear garment is worn. Loop portion 241 of the loop and hook fabric is located on the second and of the strap, such that the loop portion is located on a segment of the strap located under the horse's head when the ear garment is worn. Alternatively, the hook and loop portions of the hook and loop fabric may be located on the second and first ends, respectively.

Alternatively, other fasteners may be used besides a hook and loop fastener for joining or coupling the first and second ends of the strap together below the horse's head. In one embodiment, a first portion of a fastener can be located on the first end of the strap such that the first portion is located on the segment of the strap located under the horse's head when the ear warmer garment is worn. A second portion of a fastener can be located on the second end of the strap such that the second portion is coupled with the first portion of the fastener when the ear warmer garment is worn.

After the strap is placed on top of a horse's head and the ear cups 120 have received the ears of a horse, the first 230 and second 240 ends of the strap may be coupled or joined below the horse's head near the throat and fastened using the first and second portion of the fastener. In another embodiment (not shown), the first portion of the fastener can be a male portion of a snap and the second portion of the fastener can be a female portion of a snap. The fasteners should be adapted for allowing the first and second ends of the strap to be uncoupled if sufficient forces act upon it. This allows the equine ear warmer to be removed if caught on an exterior object thereby preventing injury to the horse. In another embodiment (not shown), the first portion of the fastener can be a buckle and the second portion of the fastener can be a hole or orifice that accommodates the buckle, similar to the method of a belt.

The strap 101 may also include an opening or cut-out 220 near the top 110. The opening can be an elongated slit and adapted such that a portion of the forelock or hair of the horse can pass through. The forelock or foretop is a part of a horse's mane that grows from the animal's poll and falls forward between the ears and onto the forehead. Allowing the forelock of the horse to rest on a portion of the strap also facilitates in maintaining the strap in position on the horse's head. In other embodiments (not shown), and opening may not be used, but rather the top 110 of the strap may include a v-shaped edge or hem that accommodates the forelock of the horse.

The various components of the ear warmer may be sewn together. However, other means of joining the components of the strap may be used. The length and size of the strap and ear cups and opening may be adjusted depending on the size of the horse. Additionally, the disclosed embodiments may also be used for protecting other animals, such as dogs and cats. During fabrication of the disclosed embodiments, the device can be sized so that it may be used for such animals.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An equine ear warmer garment, comprising:
a strap for placement around a head of a horse, the strap composed of a first material exhibiting heat insulative and water resistant capabilities;
a pair of substantially conical-shaped protrusions located on a top of said strap and composed of said first material, each conical-shaped protrusion designed for accepting an ear of a horse;
a mesh material comprising a portion of each conical-shaped protrusion such that said mesh material interrupts said first material, wherein the mesh material allows substantially full transmission of sound from an exterior source into an interior of each conical-shaped protrusion;
a hook portion of hook and loop fabric located on a first end of the strap, such that said hook portion is located on a segment of the strap located under the horse's head when the ear warmer garment is worn; and
a loop portion of hook and loop fabric located on a second end of the strap, such that said loop portion of the first end of the strap is coupled with the hook portion of the second end of the strap when the ear warmer garment is worn.

2. The equine ear warmer garment of claim 1, wherein the strap further includes an opening adapted for allowing a portion of a forelock of the horse to pass through.

3. The equine ear warmer garment of claim 2, wherein the mesh material interrupts said first material in a location that corresponds to an opening of the horse's ear, when the ear warmer garment is worn.

4. The equine ear warmer garment of claim 3, wherein the first material may be a natural or synthetic fabric that is laminated or coated with a waterproofing material.

5. The equine ear warmer garment of claim 3, wherein the first material may be a waterproof breathable fabric or membrane composed of PTFE.

6. An equine ear warmer garment, comprising:
a strap for placement around a head of a horse, the strap composed of a first material exhibiting heat insulative and water resistant capabilities;
a pair of ear cups located on a top of said strap and composed of said first material, each ear cup designed for accepting an ear of a horse;
a second material comprising a portion of each ear cup such that said second material interrupts said first material, wherein the second material allows substantially full transmission of sound waves from an exterior source into an interior of each ear cup;
a first portion of a fastener located on a first end of the strap, such that said first portion is located on a segment of the strap located under the horse's head when the ear warmer garment is worn; and,
a second portion of a fastener located on a second end of the strap, such that said second portion is coupled with the first portion of the fastener when the ear warmer garment is worn.

7. The equine ear warmer garment of claim 6, wherein the first portion of the fastener is a hook portion of hook and loop fabric and the second portion of the fastener is a loop portion of hook and loop fabric.

8. The equine ear warmer garment of claim 6, wherein the first portion of the fastener is a male portion of a snap and the second portion of the fastener is a female portion of a snap.

9. The equine garment of claim 6, wherein the strap further includes an opening adapted for allowing a portion of a forelock of the horse to pass through.

10. The equine garment of claim 9, wherein each ear cup is a conical-shaped protrusion.

11. The equine garment of claim 10, wherein the second material is a mesh material.

12. The equine ear warmer garment of claim 11, wherein the mesh material interrupts said first material in a location that corresponds to an opening of the horse's ear, when the ear warmer garment is worn.

13. The equine ear warmer garment of claim 12, wherein the first material may be a natural or synthetic fabric that is laminated or coated with a waterproofing material.

14. The equine ear warmer garment of claim 12, wherein the first material may be a waterproof breathable fabric or membrane composed of PTFE.

15. An equine ear warmer garment, comprising:
a strap for placement around a head of a horse, wherein the strap further comprises an opening adapted for allowing a portion of a forelock of the horse to pass through, the strap composed of a first material exhibiting heat insulative and water resistant capabilities;
a pair of substantially conical-shaped protrusions located on a top of said strap and composed of said first material, each conical-shaped protrusion designed for accepting an ear of a horse;
a mesh material comprising a portion of each conical-shaped protrusion such that said mesh material interrupts said first material, wherein the mesh material allows substantially full transmission of sound from an exterior source into an interior of each conical-shaped protrusion;
a hook portion of hook and loop fabric located on a first end of the strap, such that said hook portion is located on a segment of the strap located under the horse's head when the ear warmer garment is worn; and
a loop portion of hook and loop fabric located on a second end of the strap, such that said loop portion of the first end of the strap is coupled with the hook portion of the second end of the strap when the ear warmer garment is worn.

16. The equine ear warmer garment of claim 15, wherein the mesh material interrupts said first material in a location that corresponds to an opening of the horse's ear, when the ear warmer garment is worn.

17. The equine ear warmer garment of claim 16, wherein the first material may be a natural or synthetic fabric that is laminated or coated with a waterproofing material.

18. The equine ear warmer garment of claim 17, wherein the first material may be a waterproof breathable fabric or membrane composed of PTFE.
